(19) United States
(12) Patent Application Publication
(10) Pub. No.: US 2005/0155689 A1
(43) Pub. Date: Jul. 21, 2005

(54) Method and device for producing gypsum plasterboards

(76) Inventor: Hans-Joachim Smolenski, Bad Muskau (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/492,861

(22) PCT Filed: Aug. 9, 2002
(86) PCT No.: PCT/EP02/08899

(30) Foreign Application Priority Data
Aug. 17, 2001 (DE) 101394209

(51) Int. Cl. B32B 13/08

(52) U.S. Cl. 156/45

(57) ABSTRACT

Known methods for producing gypsum plasterboards that have a low specific weight are often problematic in that pores reduce adhesion between the cardboard and the gypsum. Although many attempts have been made to improve adhesion, the plasterboards cannot be produced with the desired low specific weight. The aim of the invention is therefore to achieve with little effort, an excellent adhesion between the cardboard and the gypsum and to produce boards with as low a specific weight as possible. For this purpose, after application of the gypsum onto a cardboard web and before the gypsum has set, one of the cardboard webs is subjected to a negative pressure on the side facing away from the gypsum. The invention also relates to a method for producing the inventive gypsum plasterboards.

### DESCRIPTION

The invention relates to a method of making gypsum board according to the introductory clause of claim 1 as well as to an apparatus for carrying out the method according to the introductory clause of claim 1.

For many uses of gypsum board it is desirable for the boards to be as light as possible. Thus at least a portion of the gypsum core has a network of pores that influence the density of the board. The porosity has however the disadvantage that the bond at the interface between the gypsum core and the paper liner and thus the stability of the entire gypsum board are substantially weakened.

WO 95/32084 discloses a method of making gypsum boards wherein the bond between the gypsum core and the paper liners is supposed to be improved. A first layer and two edge strips of relatively dense gypsum are applied to a lower paper liner and a second layer of less dense gypsum is applied between the edge strips. The thus formed upper surface is smoothed and covered by the upper paper liner. After some curing there is further treatment including cutting and drying of the boards.

U.S. Pat. No. 2,949,505 describes a method wherein the paper liners are coated with a thin layer of plaster and then the board is produced in the normal manner.

It is also known to applicant to use chemically impregnated liner papers with the impregnating ideally destroying the pores in the unset gypsum slurry at the interface.

The known methods and apparatuses have the disadvantage that they are expensive and associated with high costs and also produce an unsatisfactory bond between the gypsum core and the paper liners.

German 1,584,781 relates to a method of producing a gypsum board having ridges on one side by applying a gypsum slurry to a lower flat paper strip. The gypsum slurry is shaped by a doctor blade into the ribs and is then covered with an upper ridge-shaped paper strip. In order that the gypsum slurry penetrates into the ridge-forming folds of the upper paper strip, they are braced by an outside subatmospheric pressure. The thus produces a paper/gypsum/paper sandwich that is supported on a conveyor until the gypsum slurry cures and then is cut into sheets. This method does not relate to the production of gypsum boards with porous cores. The subatmospheric pressure is only applied at the ridges and thus is effective over only a small portion of the width of the system.

It is an object of the invention to provide a method of making gypsum boards that in a simple manner insures a good bond between the gypsum core and the paper liners, that has relatively dense gypsum immediately adjacent the paper liners while the remaining gypsum is as light as possible so that the resultant boards are light but strong.

A further object is the production of an apparatus for carrying out the method.

The first object is attained by the characterizing clause of claim 1.

Since after spreading the gypsum slurry and before its setting the outer face turned away from the gypsum is subjected to subatmospheric pressure, on the one hand in the region of the paper gas inclusions are eliminated from the gypsum slurry. In this manner the contact surface between paper and gypsum is increased and the bond is improved. In addition the density of the gypsum increases to the outside faces of the gypsum boards so that the finished plate has overall greater strength.

In addition water, with which the gypsum core is oversaturated, is sucked from the gypsum slurry into the paper. The thus freed gypsum crystallizes as it sets and dries and effectively knits the gypsum to the paper so that an inner bond is created that ensures the necessary bending resistance.

As a result of and in addition to the described effects of the suction it is possible to use a gypsum slurry with more gaseous inclusions. The result is a substantial reduction of weight in the finished boards without any disadvantages, e.g. with respect to strength and stability, giving substantial advantages for shipping and handling the boards.

The second object is attained by the characterizing features of claim 5.

The apparatus makes it possible to carry out the method of the invention.

The dependent claims relate to advantageous features of the invention.

The application of subatmospheric pressure at the shaping station according to claim 2 is most effective since so much free water is present.

The selection of the level of the subatmospheric pressure in combination with its application time and the porosity of the paper according to claim 3 has the effect that on the one hand enough water is aspirated in order to achieve the desired effect and on the other hand tearing the paper from too much tension as a result of too great a subatmospheric pressure is avoided.

Making a gypsum slurry with a high level of gas inclusions according to claim 4 allows boards with particularly low specific gravity to be made.

The invention is more closely described with reference to an illustrated embodiment. Therein:

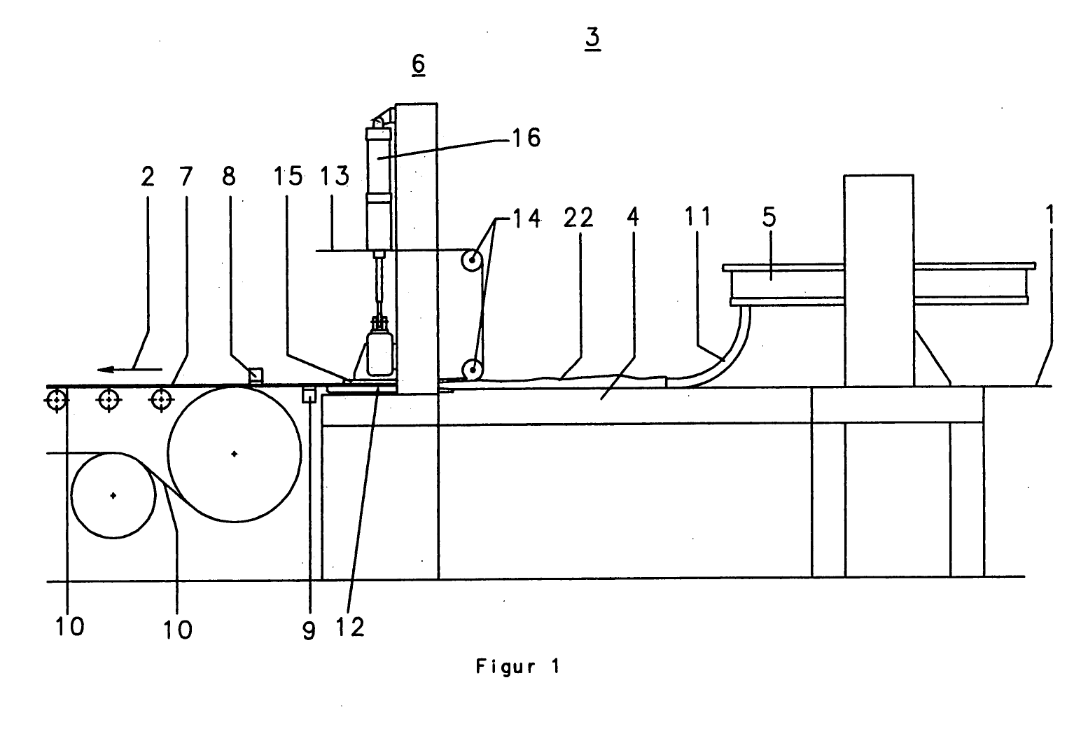

FIG. 1 is the region of the shaping station of an apparatus according to the invention for making gypsum boards with suction boxes seen from the side;

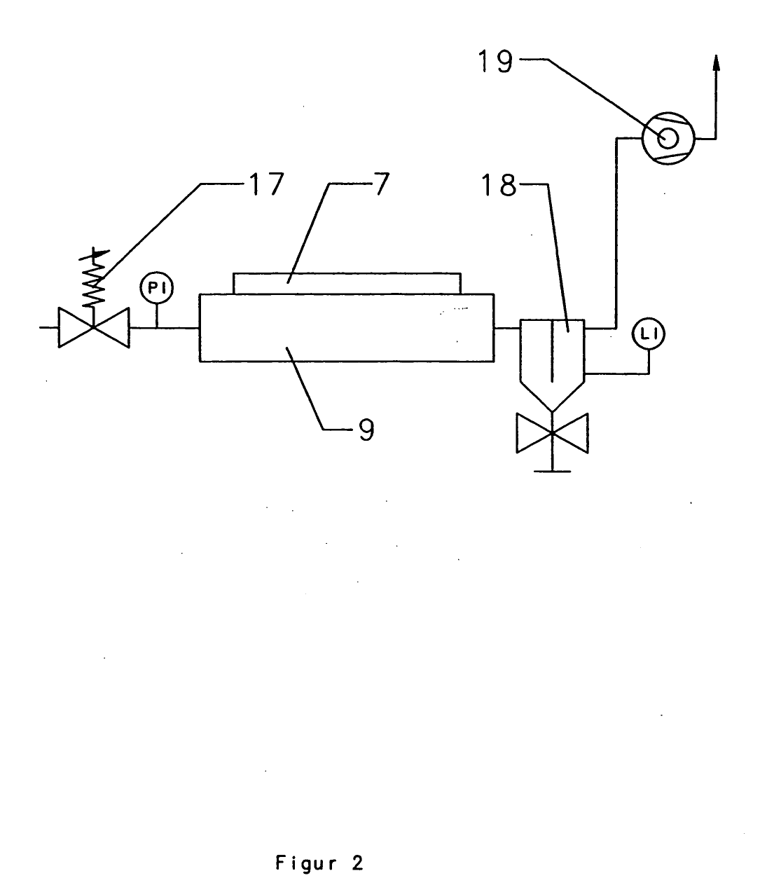

FIG. 2 schematically shows means for depressurizing a suction box; and

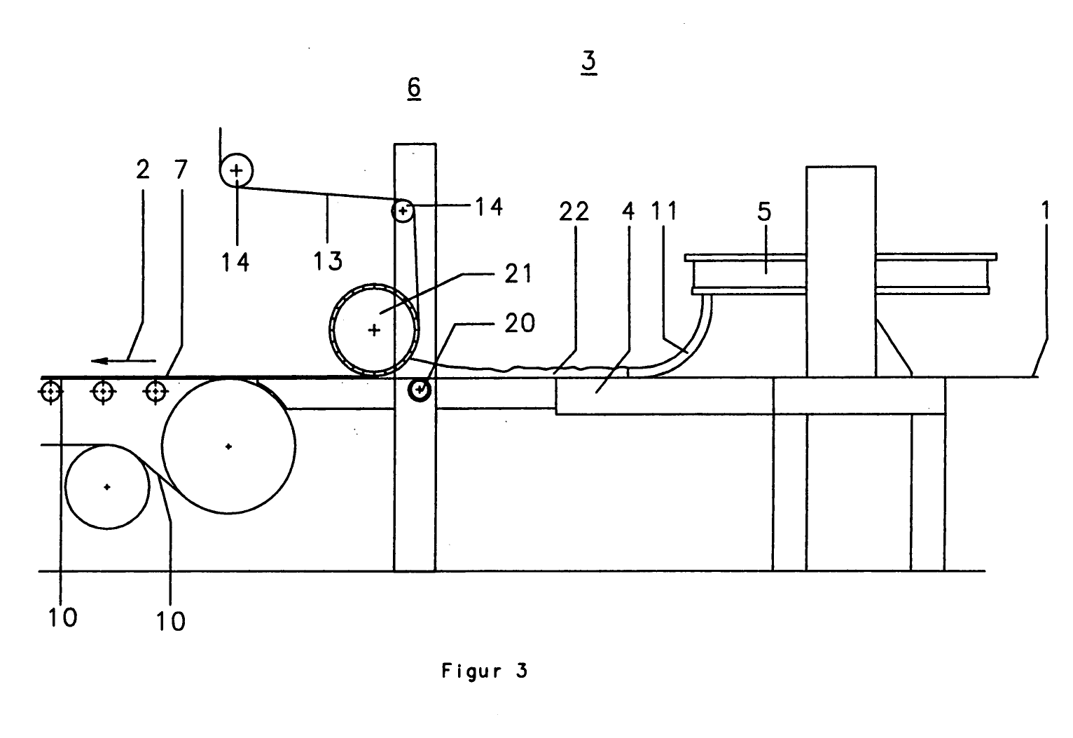

FIG. 3 is the region of the shaping station of another apparatus according to the invention with suction rollers seen from the side.

An apparatus according to the invention is comprised basically of two unwinding supplies, a shaping station, vacuum means with at least one suction device, a conveyor, at least one cutter, and a dryer. For clarity's sake, FIGS. 1 and 3 only show the region of the shaping station with the suction device.

As visible in FIG. 1 a lower paper strip 1 extends horizontally through the shaping station 3 and thence to the conveyor. The shaping station 3 is comprised generally of a machine frame with an upper horizontal plate 4 over which the paper strip 1 is guided, with a mixer 5, with means 6 for shaping a gypsum-board sandwich 7 and having suction boxes 8 and 9 forming the suction device. The conveyor 2 seen in the transport direction 2 (shown by arrow 2) downstream of the shaping station 3 is formed with a transport device constituted for example as a conveyor belt 10.

The mixer 5 is above the plate 4 and is connected to unillustrated feed lines for gypsum powder, water, and additives. The lower side of the mixer 5 has openings connected to distributors 11 oriented above the paper strip 1.

The shaping means 6 has two unillustrated lateral limiting bars that extend along the plate 4 up to the distributors 11 and that are parallel to each other and to the conveyor 2 of the paper strip 1 so as to establish the width of the gypsum-board sandwich 7. In addition the shaping means 6 has a base plate 12, a pressure plate 15, and a hydraulic cylinder 16. The upper plane of the plate 4 is flush with the upstream end of the base plate 12 that then rises going downstream and finally ends parallel to the plate 4. An upper paper strip 13 is guided over deflecting rollers 14 such that it extends downstream of the upstream edge from the base plate 12 parallel to and at a spacing from the lower paper strip 1. The pressure plate 15 extends above and parallel to the upper paper strip 13. It can be shifted vertically by the hydraulic cylinder 16 so that the spacing between the base plate 12 is and the pressure plate 15 corresponds exactly to the desired thickness of the gypsum-board sandwich 7.

As further visible in FIG. 1, the suction boxes 8 and 9 are mounted between the shaping means 6 and the conveyor belt 10. The lower suction box 9 is oriented such that its upwardly directed suction face is coplanar with the lower surface of the lower paper strip 1. This plane is identical to the plane between the upper rear edge region of the base plate 12 and the upper surface of the conveyor belt 10. The upper suction box 8 is mounted such that its downwardly directed suction face is coplanar with the lower face of the pressure plate 15.

The suction means is shown in FIG. 2: It is comprised in this embodiment mainly of the suction box 9, a pressure-maintaining valve 17, a separator 18, a suction pump 19, as well as the associated conduits and gauges, this system being set up for each suction location. The one longitudinal end of the suction box 9 is connected via the separator 18 with the suction pump 19. The other longitudinal end is connected with the pressure-maintaining valve 17.

It is also possible to provide several suction boxes 8 and 9 each with a respective separator 18 and a respective suction pump 19.

Another embodiment for the shaping station 3 is shown in FIG. 3. It is generally the same as the embodiment of FIG. 1, differing mainly in the shaping means 6 and suction means, the latter having suction rollers 20 and 21.

The shaping means 6 has two unillustrated lateral limiting bars that extend along the plate 4 up to the distributors 11 and that are parallel to each other and to the conveyor 2 of the paper strip 1 so as to establish the width of the gypsum-board sandwich 7, as well as an upper suction roller 21. The upper paper strip 13 is guided over deflecting rollers 14 to the upper suction roller 21 that is mounted rotatable about a horizontal axis perpendicular to the longitudinal axis of the lower paper strip 1 and that is vertically closely juxtaposed with the plate 4. The position of the axis is vertically adjustable. The upper paper strip 13 is guided around the upper suction roller 21 and then extends parallel to and at a spacing above the lower paper strip 1.

The shaping means includes a lower suction roller 20 set in a complementary opening of the plate 4 and rotatable such that it tangents the upper plane of the plate 4 and its axis is horizontal and perpendicular to the transport direction 2, upstream of the upper suction roller 21.

In use the lower paper strip 1 is continuously pulled from a roll and guided over the plate 4 through the shaping means 6 to the conveyor belt 10. The mixer 5 is supplied via lines with gypsum powder, water, foaming agent, and if necessary additives and forms a light gypsum slurry 22. This is spread in a uniform layer by the distributors 11 over the width of the passing lower paper strip 1. The lateral limiting bars prevent the gypsum slurry 22 from flowing over the edges of the lower paper strip 1. The upper paper strip 13 is fed from a second roll in the standard manner to the shaping means 6 where its surface is pressed into the still wet gypsum slurry and is then formed with the lower paper strip 1 and the gypsum slurry 22 into the final shape of the gypsum-board sandwich 7 with respect to thickness, width, and if necessary any special shaping of the edges. At the same time for example the edges of the lower paper strip 1, which is wider than the upper paper strip 13, are folded up and overlapped thereover.

Near the shaping means 6 wherein the gypsum slurry is not yet set, the suction devices, here for example the suction boxes 8 and 9 or the suction rollers 20 and 21, apply a subatmospheric pressure of e.g. −0.2 bar (≈0.8 bar(abs)) to the outer faces of the lower paper strip 1 and the upper paper strip 13. This has two effects: On the one hand bubbles are eliminated in the gypsum slurry inward of the paper strips 1 and 13 so that the density of the gypsum slurry immediately adjacent the paper strips 1 and 13 is higher than in the rest of the core. In particular the interface at the paper strips 1 and 13 has virtually no gaseous inclusions. On the other hand excess water in the gypsum is sucked out through the paper strips 1 and 13.

This creates a very good bond between the gypsum and the paper strips 1 and 13, thereby crating a relatively low specific weight of the finished gypsum board. The gypsum boards have a porosity that is greater at the center and decreases toward the paper liners. Thus for example a gypsum board that is 12.5 mm thick has a weight of 7.6 kg/m², whereas the standard minimum weight is 9 kg/m².

The subatmospheric pressure applied to the suction device is set in accordance for example with the type of paper and the production speed.

The shaped gypsum-board sandwich 7 is as known conveyed away so that the gypsum sets and hardens, and after setting it is cut into boards and loaded into the dryer.

1-13. (canceled)

14. A method of making gypsum boards, the method comprising the steps of:
continuously displacing through a station in a horizontal transport direction a lower liner paper strip having an upper inner face and a lower outer face;
forming a layer of a gas-entraining slurry of gypsum and water on the upper face of the lower liner paper strip at the station;
pressing a lower inner face of an upper liner paper strip having an outer upper face onto the slurry layer at the station to form a paper/gypsum/paper sandwich; and
thereafter applying suction to at least one of the outer surfaces of one of the paper strips across a full width of the one strip and thereby aspirating gas and water from the slurry at least at an interface between the one paper strip and the slurry layer.

15. The gypsum-board making method defined in claim 14 wherein the sandwich is dried and cut into boards down-stream of the station.

16. The gypsum-board making method defined in claim 14 wherein suction is applied to both of the outer surfaces.

17. The gypsum-board making method defined in claim 14 wherein the suction is applied downstream of the station.

18. The gypsum-board making method defined in claim 14 wherein the suction is applied at the station.

19. The gypsum-board making method defined in claim 14, further comprising the step of
regulating the level of suction in accordance with the speed the lower strip moves in the direction and the porosity of the one strip.

20. An apparatus for making gypsum boards, the apparatus comprising;
transport means continuously displacing through a station in a horizontal transport direction a lower liner paper strip having an upper inner face and a lower outer face;
distributor means forming a layer of a gas-entraining slurry of gypsum and water on the upper face of the lower liner paper strip at the station;
means for pressing a lower inner face of an upper liner paper strip having an outer upper face onto the slurry layer at the station to form a paper/gypsum/paper sandwich; and
means for applying suction to at least one of the outer surfaces of one of the paper strips across a full width of the one strip and thereby aspirating gas and water from the slurry at least at an interface between the one paper strip and the slurry layer.

21. The gypsum-board making apparatus defined in claim 20 wherein the suction means is downstream of the station.

22. The gypsum-board making apparatus defined in claim 20 wherein the suction means is at the station.

23. The gypsum-board making apparatus defined in claim 20 wherein the suction means includes a suction box extending the full width of the one strip.

24. The gypsum-board making apparatus defined in claim 20 wherein the suction means includes a suction roller extending the full width of the one strip.
